(19) United States
(12) Patent Application Publication
(10) Pub. No.: US 2023/0311110 A1
(43) Pub. Date: Oct. 5, 2023

(54) HONEYCOMB STRUCTURE, ELECTRICALLY HEATED CARRIER AND EXHAUST GAS PURIFICATION DEVICE

(71) Applicant: NGK Insulators, Ltd., Nagoya-City (JP)

(72) Inventor: Taro OSADA, Nagoya-City (JP)

(73) Assignee: NGK Insulators, Ltd., Nagoya-City (JP)

(21) Appl. No.: 18/166,028

(22) Filed: Feb. 8, 2023

(30) Foreign Application Priority Data
Mar. 29, 2022 (JP) 2022-054493

(51) Int. Cl. B01J 35/04; B01J 27/224; B01J 35/00; B01D 53/94; F01N 3/28; F01N 3/20

(52) U.S. Cl. CPC B01J 35/04; B01J 27/224; B01J 35/0033; B01D 53/94; F01N 3/2803; F01N 3/2026; B01D 2255/9155; B01D 2258/01; B01D 2259/4566; F01N 2330/30

(57) ABSTRACT

A honeycomb structure including a honeycomb structure portion made of ceramics having an outer peripheral wall and partition walls disposed inside the outer peripheral wall and partitioning a plurality of cells; and a pair of electrode layers provided on an outer surface of the outer peripheral wall; wherein in a cross-section orthogonal to a direction in which the cells extend, assuming a coordinate value of a center of gravity O is 0, and a coordinate value of an inner peripheral surface of the outer peripheral wall is 1.00 R, an average value P_{1A} of a porosity (%) of the partition walls in a range of coordinate values of 0 to 0.50 R and an average value P_{2A} of a porosity (%) of the partition walls in a range of coordinate values of 0.50 R to 1.00 R satisfy a relationship of 1<P_{2A}/P_{1A}.

### CROSS REFERENCE TO RELATED APPLICATIONS

The present invention claims the benefit of priority to Japanese Patent Application No. 2022-54493 filed on Mar. 29, 2022 with the Japanese Patent Office, the entire contents of which are incorporated herein by reference in its entirety.

### FIELD OF THE INVENTION

The present invention relates to a honeycomb structure, an electrically heated carrier provided with a honeycomb structure, and an exhaust gas purification device provided with an electrically heated carrier.

### BACKGROUND OF THE INVENTION

In recent years, electrically heated catalyst (EHC) has been proposed in order to improve the deterioration of exhaust gas purification performance immediately after engine starts-up. An EHC is a system that has a pair of electrodes arranged on a honeycomb structure made of conductive ceramics, and by energizing the honeycomb structure itself to generate heat, the temperature of the catalyst carried on the honeycomb structure is raised to an activation temperature before starting the engine. A honeycomb structure is required to have thermal shock resistance because high-temperature exhaust gas flows therethrough, and various techniques have been developed to improve the thermal shock resistance of a honeycomb structure.

Japanese Patent Application Publication No. 2015-174011 (Patent Literature 1) discloses a honeycomb structure in which a honeycomb structure portion is provided with one or more slits that open to the side surface, and the honeycomb structure portion has a filler filled in at least one of the slits, thereby improving the thermal shock resistance.

International Publication WO 2015/151823 (Patent Literature 2) discloses a honeycomb structure with improved thermal shock resistance by changing the opening ratio, partition wall thickness, and cell density regarding a central portion and an outer peripheral portion.

In Japanese Patent Application Publication No. 2021-133283 (Patent Literature 3), it is disclosed that in a honeycomb filter constructed by joining a plurality of honeycomb segments, thermal shock resistance is improved by increasing the partition wall thickness of the honeycomb segments in the outer peripheral portion rather than that of the honeycomb segment in the central portion.

Japanese Patent Application Publication No. 2019-198829 (Patent Literature 4) discloses a honeycomb structure in which the hydraulic diameter of the outer peripheral portion is increased.

In International Publication WO 2011/125815 (Patent Literature 5), it is disclosed that in a honeycomb structure in which the locations where a pair of electrode portions are arranged are specified so as to suppress uneven temperature distribution, from the viewpoint of improving the thermal shock resistance, it is preferable that at least one end of the pair of electrode portions does not contact (reach) the end (end surface) of the honeycomb structure.

### PRIOR ART

### Patent Literature

[Patent Literature 1] Japanese Patent Application Publication No. 2015-174011

[Patent Literature 2] International Publication WO 2015/151823

[Patent Literature 3] Japanese Patent Application Publication No. 2021-133283

[Patent Literature 4] Japanese Patent Application Publication No. 2019-198829

[Patent Literature 5] International Publication WO 2011/125815

### SUMMARY OF THE INVENTION

In recent years, the maximum temperature of exhaust gases from internal combustion engines has risen due to the influence of fuel efficiency regulations on automobiles, and further improvement in thermal shock resistance is required. In particular, when a crack occurs in the side surface of a honeycomb structure, electricity will not flow to the cracked portion, so there is a possibility that the heat generation performance required during energization may not be satisfied. Therefore, there is a demand for a new technique capable of suppressing cracks occurring on the side surface of a honeycomb structure due to the thermal shock caused by the exhaust gas.

One factor that causes cracks on the side surface is the generation of thermal stress due to an excessively large temperature difference between the central portion and the outer peripheral portion in the temperature distribution in the radial direction of the base material. In the above-mentioned patent literatures, there are disclosed a technique in which one or more slits having opening on the side surface are formed to concentrate the thermal stress on the slit portions and relax the thermal stress applied to the base material, or technique in which the opening ratio, partition wall thickness, and cell density were changed between the central portion and the outer peripheral portion to improve the temperature distribution in the radial direction. However, there is a concern that the formation of slits on the side surface may reduce the strength of the honeycomb structure. Further, if the cell structure such as the opening ratio, partition wall thickness, and cell density is greatly changed between the central portion and the outer peripheral portion, the partition walls are likely to be deformed at the changing locations, and there is a concern that the strength of the honeycomb structure may be lowered due to shape distortion.

In view of the above circumstances, in one embodiment, an object of the present invention is to provide a honeycomb structure with improved thermal shock resistance and in which side cracks are less likely to occur. In another embodiment, an object of the present invention is to provide an electrically heated carrier provided with such a honeycomb structure. In yet another embodiment, an object of the present invention is to provide an exhaust gas purification device provided with such an electrically heated carrier.

One embodiment of the present invention provides a honeycomb structure, comprising:
a honeycomb structure portion made of ceramics, comprising an outer peripheral wall; and partition walls disposed inside the outer peripheral wall and partitioning a plurality of cells which penetrate from one end surface to the other end surface and form flow paths; and
a pair of electrode layers provided on an outer surface of the outer peripheral wall so as to face each other across a central axis of the honeycomb structure;
wherein in a cross-section orthogonal to a direction in which the cells extend, assuming a coordinate value of a center of gravity O is 0, and a coordinate value of an inner peripheral surface of the outer peripheral wall is 1.00 R, an average value P_{1A} of a porosity (%) of the partition walls in a range of coordinate values of 0 to 0.50 R and an average value P_{2A} of a porosity (%) of the partition walls in a range of coordinate values of 0.50 R to 1.00 R satisfy a relationship of 1<P_{2A} /P_{1A}.

In another embodiment, the present invention provides an electrically heated carrier, comprising:
the honeycomb structure; and
a metal terminal joined to an outer surface of each of the pair of electrode layers;

In yet another embodiment, the present invention provides an exhaust gas purification device, comprising:
the electrically heated carrier; and
a tubular metal pipe accommodating the electrically heated carrier.

In one embodiment of the present invention, it is possible to provide a honeycomb structure with improved thermal shock resistance and in which cracks on side surface are less likely to occur. Therefore, for example, by applying the honeycomb structure to an EHC, it is possible to provide an EHC in which cracks are less likely to occur even when rapidly heated by high-temperature exhaust gas and which has excellent thermal shock resistance. In addition, although the honeycomb structure according to one embodiment of the present invention does not require slits formed on the side surface, a slit formation may be formed, and the provision of slit formation is not excluded from the present invention. Moreover, even when slits are formed, it is possible to finish with slit formation that have less influence on the strength than in the conventional art.

### BRIEF DESCRIPTION OF THE DRAWINGS

FIG. 1 is a schematic view of an electrically heated carrier according to one embodiment of the present invention when observed from one end surface.

FIG. 2 is a schematic perspective view of an electrically heated carrier according to one embodiment of the present invention.

FIG. 3 is a schematic view of a cross-section orthogonal to the direction in which the cells extend in a honeycomb structure according to one embodiment of the present invention.

FIG. 4 is a schematic view of a cross-section orthogonal to the direction in which the cells extend in a honeycomb structure according to another embodiment of the present invention.

FIG. 5 is a schematic view of a cross-section orthogonal to the direction in which the cells extend in a honeycomb structure according to yet another embodiment of the present invention.

FIG. 6 is a schematic view of a cross-section showing an exhaust gas purification device according to one embodiment of the present invention.

### DETAILED DESCRIPTION OF THE INVENTION

Hereinafter, embodiments of the present invention will now be described in detail with reference to the drawings. It should be understood that the present invention is not intended to be limited to the following embodiments, and any change, improvement or the like of the design may be appropriately added based on ordinary knowledge of those skilled in the art without departing from the spirit of the present invention.

### (1. Electrically Heated Carrier)

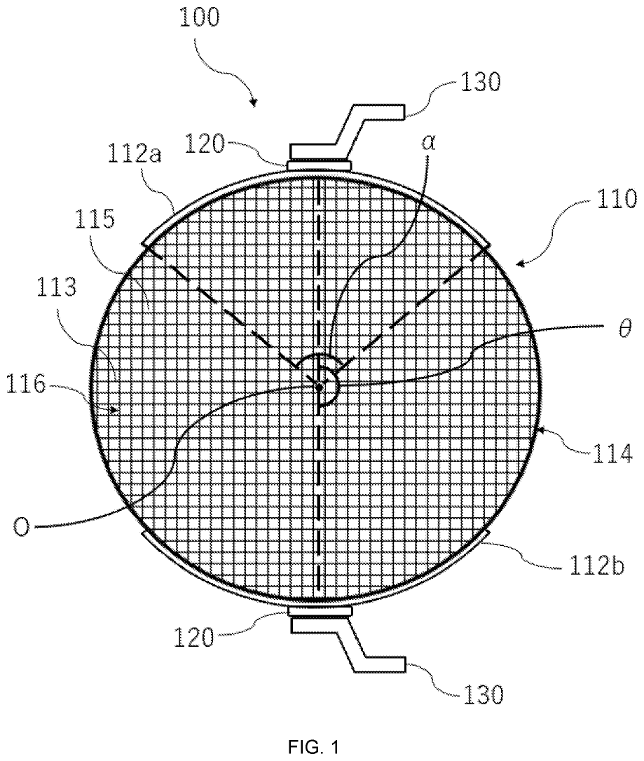

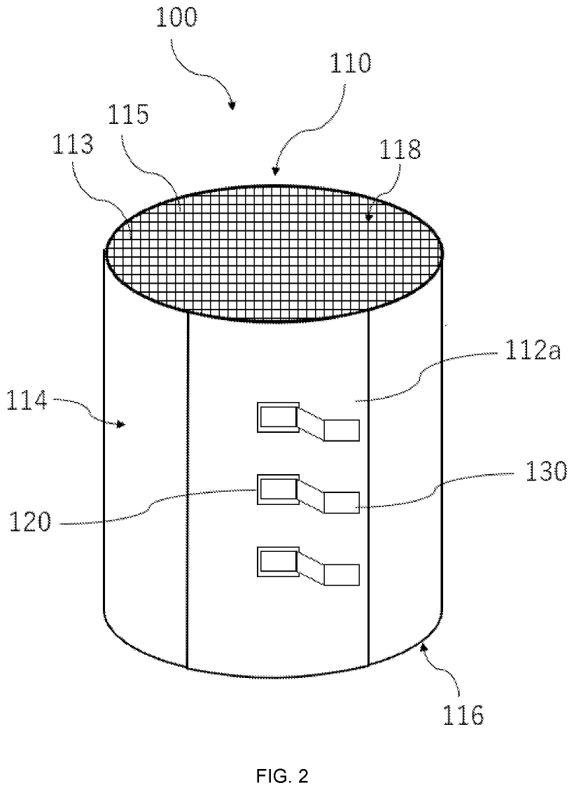

FIG. 1 is a schematic view of an electrically heated carrier 100 according to one embodiment of the present invention when observed from one end surface 116. FIG. 2 is a schematic perspective view of the electrically heated carrier 100 according to one embodiment of the present invention. An electrically heated carrier 100 comprises a honeycomb structure 110 and metal terminals 130. By carrying a catalyst on the electrically heated carrier 100, the electrically heated carrier 100 can be used as a catalyst carrier.

Examples of catalysts include precious metal catalysts and other catalysts. As a precious metal catalyst, examples include three-way catalysts and oxidation catalysts carrying precious metals such as platinum (Pt), palladium (Pd), and rhodium (Rh) on the surface of alumina pores, and containing co-catalysts such as ceria and zirconia, or lean NOₓ trap catalysts (LNT catalysts) containing an alkaline earth metal and platinum as nitrogen oxide (NOₓ) storage components. Examples of catalysts that do not use precious metals include NOₓ selective reduction catalysts (SCR catalysts) containing copper-substituted or iron-substituted zeolites. Further, two or more catalysts selected from these catalysts may be used. The method for carrying the catalyst is also not particularly limited, and a known method for carrying the catalyst on the honeycomb structure can be employed.

### (1-1. Honeycomb Structure)

In one embodiment, the honeycomb structure 110 comprises:
a honeycomb structure portion made of ceramics, comprising an outer peripheral wall 114; and partition walls 113 disposed inside the outer peripheral wall 114 and partitioning a plurality of cells 115 forming flow paths from one end surface 116 to the other end surface 118 and form flow paths; and
a pair of electrode layers 112a, 112bprovided on an outer surface of the outer peripheral wall 114 so as to face each other across a central axis of the honeycomb structure portion;

The outer shape of the honeycomb structure 110 is not particularly limited, and may be, for example, a pillar shape having round end surfaces such as circular, oval, elliptical, racetrack and elongated circle shapes, a pillar shape having polygonal shaped end surfaces such as a triangle or a quadrangle, and a pillar shape having other irregular-shaped end surfaces. The illustrated honeycomb structure 110 has a circular end surface shape and a cylindrical shape as a whole.

The height of the honeycomb structure 110 (the length from one end surface to the other end surface) is not particularly limited, and may be appropriately set according to the applications and required performance. The relationship between the height of the honeycomb structure and the maximum diameter of each end surface (that is, the maximum length of the diameters passing through the center of gravity of each end surface of the honeycomb structure) is not particularly limited either. Therefore, the height of the honeycomb structure may be longer than the maximum diameter of each end surface, or the height of the honeycomb structure may be shorter than the maximum diameter of each end surface.

In addition, in order to improve the heat resistance (to suppress cracks occurring in the circumferential direction of the outer peripheral wall), the size of the honeycomb structure 110 is preferably such that the area of one end surface is 2,000 to 20,000 mm², and more preferably 5,000 to 15,000 mm².

The outer peripheral wall 114 and the partition walls 113 have higher volume resistivity than the electrode layers 112a and 112b, but are electrically conductive. The volume resistivity of the outer peripheral wall 114 and the partition walls 113 is not particularly limited as long as they can generate heat by Joule heat when energized, but it is preferably 0.1 to 200 Ω·cm, more preferably 1 to 200 Ω·cm, and even more preferably 10 to 100 Ω·cm, when measured at 25° C. by a four-terminal method.

As the material of the outer peripheral wall 114 and the partition walls 113, ceramics (conductive ceramics) capable of generating heat by Joule heat when energized can be used in one type or in combination of two or more types. The material of the outer peripheral wall 114 and the partition walls 113 is not limited, but may comprise one or more selected from oxide ceramics such as alumina, mullite, zirconia and cordierite, and non-oxide ceramics such as silicon carbide, silicon nitride and aluminum nitride. In addition, a silicon carbide-silicon composite material, a silicon carbide/graphite composite material, or the like can also be used. Among these materials, from the viewpoint of achieving both heat resistance and conductivity, it is preferable that the outer peripheral wall 114 and the partition walls 113 be mainly composed of a silicon carbide-silicon composite material or silicon carbide. When it is said that the material of the outer peripheral wall 114 and the partition walls 113 is mainly composed of the silicon carbide-silicon composite material, it means that the outer peripheral wall 114 and the partition walls 113 comprise 90% by mass or more of the silicon carbide-silicon composite material (total mass), respectively. Here, the silicon carbide-silicon composite material contains silicon carbide particles as an aggregate and silicon as a binder for binding the silicon carbide particles, and it is preferable that multiple silicon carbide particles are joined by the silicon so as to form pores among the silicon carbide particles. When it is said that the material of the outer peripheral wall 114 and the partition walls 113 is mainly composed of silicon carbide, it means that the outer peripheral wall 114 and the partition walls 113 comprise 90% by mass or more of silicon carbide (total mass), respectively.

When the outer peripheral wall 114 and the partition walls 113 contain a silicon carbide-silicon composite material, a ratio of the “mass of silicon as a binder” contained in the outer peripheral wall 114 and the partition walls 113 to a total of the “mass of silicon carbide particles as an aggregate” contained in the outer peripheral wall 114 and the partition walls 113 and the “mass of silicon as a binder” contained in the outer peripheral wall 114 and the partition walls 113 is preferably 10 to 40% by mass, more preferably 15 to 35% by mass, respectively. When it is 10% by mass or more, the strength of the outer peripheral wall 114 and the partition walls 113 is sufficiently maintained. When it is 40% by mass or less, it becomes easier to retain the shape during firing.

When a high-temperature gas flows through the honeycomb structure 110, the flow rate of the gas flowing through the honeycomb structure 110 is likely to be greater in the central portion than in the outer peripheral portion. Therefore, the temperature of the honeycomb structure 110 tends to be higher in the central portion than in the outer peripheral portion. Therefore, in order to improve the thermal shock resistance of the honeycomb structure 110, it is desirable to make the heat capacity of the outer peripheral portion smaller than that of the central portion in order to reduce the temperature difference between the central portion and the outer peripheral portion.

As a means for changing the heat capacity of the honeycomb structure 110, a method of changing the cell structure such as the opening ratio, the partition wall thickness, and the cell density can be considered as described above. However, a large change in the cell structure tends to cause deformation of the partition walls, so that the adverse effect on the strength cannot be ignored. On the other hand, by using a technique of making the partition walls 113 porous and changing the porosity, it is possible to change the heat capacity without changing the cell structure. Therefore, according to one embodiment of the present invention, the porosity of the peripheral portion of the partition walls 113 is made higher than that of the central portion in order to improve the thermal shock resistance.

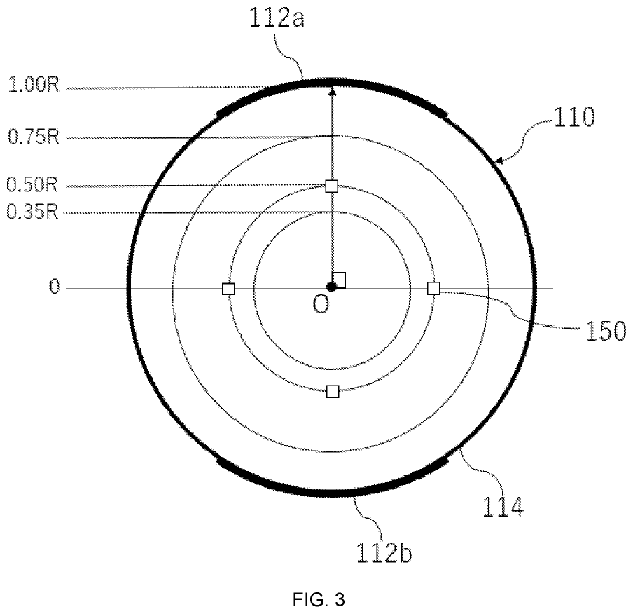

FIG. 3 shows a schematic view of a cross-section orthogonal to the direction in which the cells 115 extend in the honeycomb structure 110 according to one embodiment of the present invention. In this cross-section, assuming the coordinate value of the center of gravity O is 0, and the coordinate value of the inner peripheral surface of the outer peripheral wall 114 is 1.00 R, the average value P_{1A} of the porosity (%) of the partition walls 113 in the range of coordinate values of 0 to 0.50 R and the average value P_{2A} of the porosity (%) of the partition walls 113 in the range of coordinate values of 0.50 R to 1.00 R satisfy a relationship of 1<P_{2A}/P_{1A}. In order to enhance the thermal shock resistance, it is preferable to satisfy the relationship of 1.08≤P_{2A}/P_{1A}≤2.5, more preferably to satisfy the relationship of 1.61≤P_{2A}/P_{1A}≤2.5, and even more preferable to satisfy the relationship of 2.2≤P_{2A} /P_{1A}≤2.5.

The average porosity P_{1A} of the partition walls 113 in the range of coordinate values of 0 to 0.50 R is preferably 30 to 60%, more preferably 35 to 60%, and even more preferably 35 to 45%. When P_{1A} is 30% or more, it becomes easier to suppress deformation during firing. When P_{1A} is 60% or less, the strength of honeycomb structure 110 is sufficiently maintained.

In a preferred embodiment, regarding the porosity of the partition walls 113, a ratio of the porosity at the coordinate value of 0.35 R to the porosity at the coordinate value of 0 is 0.9 to 1.5, a ratio of the porosity at the coordinate value of 0.75 R to the porosity at the coordinate value of 0.35 R is 1.1 to 2.5, and a ratio of the porosity at the coordinate value 1.00 R to the porosity at the coordinate value of 0.75 R is 0.9 to 1.5. Giving a relatively large change in the porosity of the partition walls 113 in the range from the coordinate value of 0.35 R to the coordinate value of 0.75 R makes it easy to suppress the temperature change in the radial direction. The ratio of the porosity at the coordinate value of 0.35 R to the porosity at the coordinate value of 0 is preferably 1.0 to 1.5, more preferably 1.1 to 1.5. The ratio of the porosity at the coordinate value of 0.75 R to the porosity at the coordinate value of 0.35 R is preferably 1.5 to 2.5, more preferably 2.0 to 2.5. The ratio of the porosity at the coordinate value 1.00 R to the porosity at the coordinate value of 0.75 R is preferably 1.0 to 1.5, more preferably 1.1 to 1.5. In this case, it is preferable that the porosity of the partition walls 113 increase stepwise or gradually toward the inner surface of the outer peripheral wall 114 at least in the range from the coordinate value of 0.35 R to the coordinate value of 0.75 R.

In a more preferred embodiment, the porosity of the partition walls 113 increases stepwise or gradually from the center of gravity O toward the inner peripheral surface of the outer peripheral wall 114 from the coordinate value of 0 to the coordinate value of 1.00 R. When the porosity gradually increases, the temperature change in the radial direction can be moderated compared to when the porosity shifts rapidly.

When it is said the porosity gradually increases, it means that assuming the porosity at a certain coordinate value is P₁ and the porosity at a coordinate value located on the outer peripheral side of this coordinate value by adding 0.05 R is P₂, 1.0<P₂/P₁≤2.5 is satisfied. Accordingly, for example, when it is said that the porosity of the partition walls 113 increases gradually from the center of gravity O toward the inner peripheral surface of the outer peripheral wall 114 from the coordinate value of 0 to the coordinate value 1.00 R, it means the above relational expression always holds for any coordinate values from coordinate value of 0 to coordinate value 1.00 R.

From the viewpoint of not giving a significant change to the cell structure, it is preferable that the average thickness T_{1A} of the partition walls 113 in the range of coordinate values of 0 to 0.50 R and the average thickness T_{2A} of the partition walls 113 in the range of coordinate values of 0.50 R to 1.00 R satisfy a relationship of 0.9≤T_{2A}/T_{1A}≤1.1, more preferably 0.95≤T_{2A}/T_{1A}≤1.05, and even more preferably 0.98≤T_{2A}/T_{1A}≤1.02.

The average thickness T_{1A} of the partition walls 113 in the range of coordinate values of 0 to 0.50 R is preferably 0.10 to 0.30 mm, more preferably 0.15 to 0.25 mm. When the average thickness T_{1A} of the partition walls 113 is 0.10 mm or more, it is possible to suppress decreasing of the strength of the honeycomb structure 110. When the average thickness T_{1A} of the partition walls 113 is 0.30 mm or less, if the honeycomb structure 110 is used as a catalyst carrier to carry a catalyst, it is possible to suppress an increase in pressure loss when the exhaust gas flows.

From the viewpoint of not giving a significant change to the cell structure, it is preferable that the cell density D_{1A} in the range of coordinate values of 0 to 0.50 R and the cell density D_{2A} in the range of coordinate values of 0.50 R to 1.00R satisfy a relationship of 0.9≤D_{2A}/D_{1A} ≤1.1, more preferably 0.95≤D_{2A}/D_{1A} ≤1.05, even more preferably 0.98≤D_{2A}/D_{1A}≤1.02.

The cell density D_{1A} in the range of coordinate values of 0 to 0.50 R is preferably 40 to 150 cells/cm², more preferably 70 to 100 cells/cm², in the cross-section perpendicular to the direction in which the cells 115 extend. By setting the cell density D_{1A} within such a range, the purification performance of the catalyst can be enhanced while reducing the pressure loss when exhaust gas is caused to flow through the honeycomb structure 110. When the cell density D_{1A} is 40 cells/cm² or more, a sufficient catalyst carrying area is ensured.

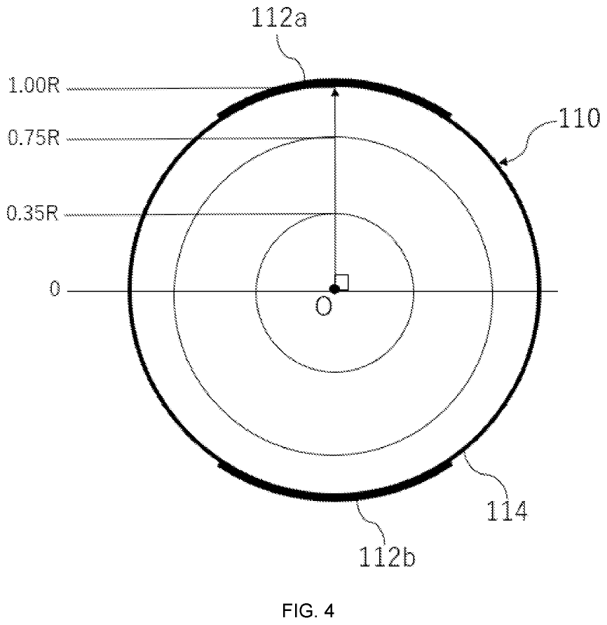

FIG. 4 shows a schematic view of a cross-section perpendicular to the direction in which the cells 115 extend in the honeycomb structure 110 according to another embodiment of the present invention. In this cross-section, assuming the coordinate value of a center of gravity O is 0, and the coordinate value of the inner peripheral surface of the outer peripheral wall is 1.00 R, it is preferable that the average value P_{1B} of the porosity (%) of the partition walls in the range of coordinate values of 0 to 0.35 R, the average value P_{2B} of the porosity (%) of the partition walls in the range of coordinate values of 0.35 R to 0.75 R, and the average value P_{3B} of the porosity (%) of the partition walls in the range of coordinate values of 0.75 R to 1.00 R satisfy a relationship of P_{1B}<P_{3B}, and more preferably, the relationships P_{1B}≤P_{2B}<P_{3B} or P_{1B}<P_{2B}≤P_{3B} is satisfied. In order to increase thermal shock resistance, it is preferable that the relationships of 1.1≤P_{2B}/P_{1B}<2.5, 1.1 ≤P_{3B}/P_{2B}≤2.5, and 1.21≤P_{3B}/P_{1B}≤2.5 be satisfied, more preferable that the relationships of 1.2≤P_{2B}/P_{1B}≤2.5, 1.2≤P_{3B}/P_{2B}≤2.5, and 1.44≤P_{3B}/P_{1B}≤2.5 be satisfied, and even more preferable that the relationships of 1.5≤P_{2B}/P_{1B}≤2.5, 1.5 P_{3B}/P_{2B}≤2.5, and 2.25≤P_{3B}/P_{1B}≤2.5 be satisfied.

The average value P_{1B} of the porosity (%) of the partition walls in the range of coordinate values of 0 to 0.35 R is preferably 30 to 60%, more preferably 35 to 60%, and even more preferably 35 to 45%. When P_{1B} is 30% or more, it becomes easier to suppress deformation during firing. When P_{1B} is 60% or less, the strength of the honeycomb structure 110 is sufficiently maintained.

From the viewpoint of not giving a significant change to the cell structure, it is preferable that the average thickness T_{1B} of the partition walls in the range of coordinate values of 0 to 0.35 R, the average thickness T_{2B} in the range of coordinate values of 0.35 R to 0.75 R, and the average thickness T_{3B} in the range of coordinate values of 0.75 R to 1.00 R satisfy the relationships of 0.9≤T_{2B}/T_{1B}≤1.1, 0.9≤T_{3B}/T_{2B}≤1.1, and 0.9≤T_{3B}/T_{1B}≤1.1, more preferable that the relationships of 0.95 T_{2B} / T_{1B} 1.05, 0.95 T_{3B} /T_{2B}≤1.05, and 0.95≤T_{3B}/T_{1B}≤1.05 be satisfied, and even more preferable that the relationships of 0.98≤T_{2B}/T_{1B}≤1.02, 0.98≤T_{3B}/T_{2B}≤1.02, and 0.98≤T_{3B}/T_{1B}≤1.02 be satisfied.

The average thickness T_{1B} of the partition wall 113 in the range of coordinate values of 0 to 0.35 R is preferably 0.05 to 0.30 mm, more preferably 0.10 to 0.25 mm. When the average thickness T_{1B} of the partition walls 113 is 0.05 mm or more, it is possible to suppress decreasing of the strength of the honeycomb structure 110. When the average thickness T_{1B} of the partition walls 113 is 0.30 mm or less, if the honeycomb structure 110 is used as a catalyst carrier to carry a catalyst, it is possible to suppress an increase in pressure loss when the exhaust gas flows.

From the viewpoint of not giving a significant change to the cell structure, it is preferable that the cell density D_{1B} in the range of coordinate values of 0 to 0.35 R, the cell density D_{2B} in the range of coordinate values of 0.35 R to 0.75 R, and the cell density D_{3B} in the range of coordinate values of 0.75 R to 1.00 R satisfy the relationships of 0.9≤D_{2B}/D_{1B}≤1.1, 0.9≤D_{3B}/D_{2B}≤1.1, and 0.9≤D_{3B}/D_{1B}1.1, more preferable that the relationships of 0.95≤D_{2B}/D_{1B}1.05, 0.95≤D_{3B}/D_{2B}≤1.05, and 0.95≤D_{3B}/D_{1B}≤1.05 be satisfied, and even more preferable that the relationships of 0.98≤D_{2B}/D_{1B}≤1.02, 0.98≤D_{3B}/D_{2B}≤1.02, and 0.98≤D_{3B}/D_{1B}≤1.02 be satisfied.

The cell density D_{1B} in the range of coordinate values of 0 to 0.35 R is preferably 40 to 150 cells/cm², more preferably 70 to 100 cells/cm² in the cross-section perpendicular to the direction in which the cells 115 extend. By setting the cell density D_{1B} within such a range, the purification performance of the catalyst can be enhanced while reducing the pressure loss when exhaust gas is caused to flow through the honeycomb structure 110. When the cell density D_{1B} is 40 cells/cm² or more, a sufficient catalyst carrying area is ensured.

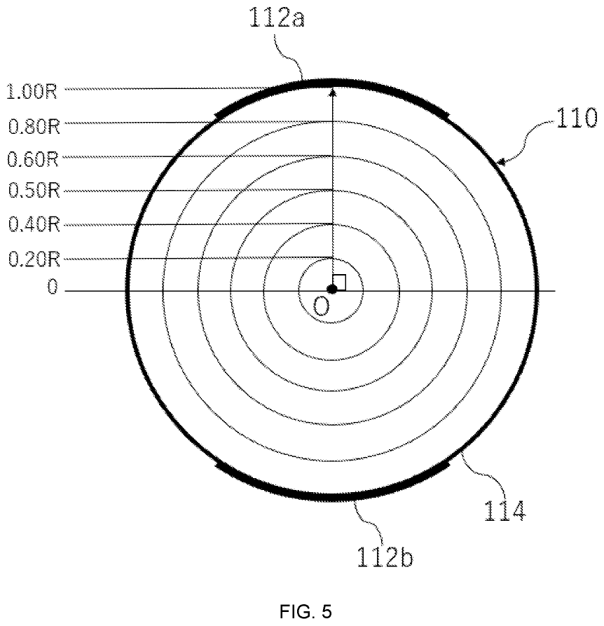

FIG. 5 a schematic view of a cross-section orthogonal to the direction in which the cells 115 extend in a honeycomb structure 110 according to yet another embodiment of the present invention. In this cross-section, assuming the coordinate value of the center of gravity O is 0, and the coordinate value of the inner peripheral surface of the outer peripheral wall 114 is 1.00 R, it is preferable that the average value P_{1C} of the porosity (%) of the partition walls in the range of coordinate values of 0 to 0.20 R, the average value Pec of the porosity (%) of the partition walls in the range of coordinate values of 0.20 R to 0.40 R, the average value P_{3C} of the porosity (%) of the partition walls in the range of coordinate values of 0.40 R to 0.60 R, the average value P_{4C} of the porosity (%) of the partition walls in the range of coordinate values of 0.60 R to 0.80 R, and the average value P_{5C} of the porosity (%) of the partition walls in the range of coordinate values of 0.80 R to 1.00 R satisfy the relationship of P_{1C}<P_{5C}, more preferable that the relationship of P_{1C}≤P_{2C}≤P_{3C}≤P_{4C}<P_{5C}, or P_{1C}≤P_{2C}≤P_{3C}≤P_{4C}≤P_{5C}, or P_{1C}≤P_{2C}>P_{3C}≤P_{4C}<P_{5C}, or P_{1C}<P_{2C}≤P_{3C}≤P_{4C}<P_{5C} or be satisfied. To improve thermal shock resistance, it is preferable that the relationships of 1.1≤P_{2C}/P_{1C}<2.5, 1.1≤P_{3C}/P_{2C}<2.5, 1.1≤P_{4C}/P_{3C}<2.5, 1.1≤P_{5C}/P_{4C}<2.5, and 1.46≤P_{5C}/P_{1C}≤2.5 be satisfied, and even more preferable that the relationships of 1.2≤P_{2C}/P_{1C}≤2.5, 1.2≤P_{3C}/P_{2C}≤2.5, 1.2≤P_{4C}/P_{3C}≤2.5, 1.2≤P_{5C}/P_{4C}≤2.5, and 2.07≤P_{5C}/P_{1C}≤2.5 be satisfied.

The average value Pic of the porosity (%) of the partition walls in the range of coordinate values of 0 to 0.20 R is preferably 30 to 60%, more preferably 35 to 60%, and even more preferably 35 to 45%. When P_{1C} is 30% or more, it becomes easier to suppress deformation during firing. When P_{1C} is 60% or less, the strength of honeycomb structure 110 is sufficiently maintained.

From the viewpoint of not giving a significant change to the cell structure, it is preferable that the average thickness T_{1C} of the partition walls in the range of coordinate values of 0 to 0.20 R, the average thickness T_{2C} of the partition walls in the range of coordinate values of 0.20 R to 0.40 R, the average thickness T_{3C} of the partition walls in the range of coordinate values of 0.40 R to 0.60 R, the average thickness T_{4C} of the partition walls in the range of coordinate values of 0.60 R to 0.80 R, and the average thickness T_{5C} of the partition walls in the range of coordinate values of 0.80 R to 1.00 R satisfy 0.9≤T_{2C}/T_{1C}≤1.1, 0.9≤T_{3C}/T_{2C}≤1.1, 0.9≤T_{4C}/T_{3C}≤1.1, 0.9≤T_{5C}/T_{4C}≤1.1, and 0.9≤T_{5C}/T_{1C}≤1.1, more preferable that 0.95≤T_{2C}/T_{1C≤}1.05, 0.95≤T_{3C}/T_{2C}≤1.05, 0.95≤T_{4C}/T_{3C}≤1.05, 0.95≤T_{5C}/T_{4C≤}1.05, and 0.95≤T_{5C}/T_{1C}≤1.05 are satisfied, and even more preferable that 0.98≤T_{2C}/T_{1C≤}1.02, 0.98≤T_{3C}/T_{2C}≤1.02, 0.98≤T_{4C}/T_{3C}≤1.02, 0.98≤T_{5C}/T_{4C≤}1.02, and 0.98≤T_{5C}/T_{1C}≤1.02 are satisfied.

The average thickness T_{1C} of the partition walls 113 in the range of coordinate values of 0 to 0.20 R is preferably 0.05 to 0.3 mm, more preferably 0.10 to 0.25 mm. When the average thickness T_{1C} of the partition walls 113 is 0.05 mm or more, it is possible to suppress decreasing of the strength of the honeycomb structure 110. When the average thickness T_{1C} of the partition walls 113 is 0.30 mm or less, if the honeycomb structure 110 is used as a catalyst carrier to carry a catalyst, it is possible to suppress an increase in pressure loss when the exhaust gas flows.

From the viewpoint of not giving a significant change to the cell structure, it is preferable that the cell density D_{1C} in the range of coordinate values of 0 to 0.20 R, the cell density D_{2C} in the range of coordinate values of 0.20 R to 0.40 R, the cell density D_{3C} in the range of coordinate values of 0.40 R to 0.60 R, the cell density D_{4C} in the range of coordinate values of 0.60 R to 0.80 R, and the cell density D_{5C} in the range of coordinate values of 0.80 R to 1.00 R satisfy 0.9≤D_{2C}/D_{1C≤}1.1, 0.9≤D_{3C}/D_{2C}≤1.1, 0.9≤D_{4C}/D_{3C}≤1.1, 0.9≤D_{5C}/D_{4C}≤1.1, and 0.9≤D_{5C}/D_{1C≤}1.1, more preferable that 0.95≤D_{2C}/D_{1C}≤1.05, 0.95≤D_{3C}/D_{2C}≤1.05, 0.95≤D_{4C}/D_{3C}≤1.05, 0.95≤D_{5C}/D_{4C}≤1.05, and 0.95≤D_{5C}/D_{1C≤}1.05 be satisfied, and even more preferable that 0.98≤D_{2C}/D_{1C}≤1.02, 0.98≤D_{3C}/D_{2C}≤1.02, 0.98≤D_{4C}/D_{3C}≤1.02, 0.98≤D_{5C}/D_{4C}≤1.02, and 0.98≤D_{5C}/D_{1C≤}1.02 be satisfied.

The cell density D_{1C} in the range of coordinate values of 0 to 0.20 R is preferably 40 to 150 cells/cm², more preferably 70 to 100 cells/cm² in the cross-section perpendicular to the direction in which the cells 115 extend. By setting the cell density P_{1C} within such a range, the purification performance of the catalyst can be enhanced while reducing the pressure loss when exhaust gas is caused to flow through the honeycomb structure 110. When the cell density D_{1C} is 40 cells/cm² or more, a sufficient catalyst carrying area is ensured.

In this specification, the porosity can be determined as follows. That is, each of the above-described measurement points (area of 1 mm length×1 mm width of the honeycomb structure portion is observed with a scanning electron microscope (SEM), and its SEM image is obtained. Note that the SEM image is to be observed by enlarging it 200 times. Next, the obtained SEM image is analyzed to binarize the solid portions of the partition walls and the void portions (pores) in the partition walls in the cross-section perpendicular to the direction in which the cells extend in the honeycomb structure portion. Then, the percentage of the ratio of the void portions in the partition walls to the total area of the solid portions and the void portions of the partition walls is calculated, and this value is taken as the porosity of the honeycomb structure portion. In addition, when measuring the porosity of an electrically heated catalyst carrier having a catalyst carried on a honeycomb structure, the catalyst portions are regarded as the void portions of the partition walls.

When measuring the porosity at each coordinate value, an arbitrary cross-section perpendicular to the direction in which the cells extend in the honeycomb structure is cut out, and four samples (1 mm length×1 mm width×10 mm depth) are cut out from the honeycomb structure at equal intervals in the circumferential direction (every 90°) so that the specific coordinate value to be measured crosses the center of the sample. FIG. 3 schematically shows locations where four samples 150 were taken from the honeycomb structure 110 when measuring the porosity at the coordinate value of 0.50 R. Less than four samples may be acceptable for locations where the coordinate values are so small (for example, close to 0) that samples cannot be taken from four locations. For the point with a coordinate value of 0, a sample is taken so that the center of gravity of the sample is located at the place with the coordinate value of 0 (the center of gravity O). For the point with a coordinate value of 1.00 R, samples are taken so that the outer peripheral wall is included. The average value of the porosity of the four samples is calculated and it is set as the porosity at the specific coordinate value.

By repeating the porosity measurement for each coordinate difference of 0.05 R from coordinate values of 0 to 1.00 R by the above method, the porosity is obtained at the coordinate values of 0, 0.05 R, 0.10 R, 0.15 R, 0.20 R, 0.25 R, 0.30 R, 0.35 R, 0.40 R, 0.45 R, 0.50 R, 0.55 R, 0.60 R, 0.65 R, 0.70 R, 0.75 R, 0.80 R, 0.85 R, 0.90 R, 0.95 R, and 1.00R in the radial direction.

When obtaining the average value of porosity in a specific coordinate range, the average value of porosities including both end points of the specific coordinate range is obtained from the values of porosity in each of the coordinate values. For example, the average value P_{1C} of the porosity (%) of the partition walls in the range of coordinate values of 0 to 0.20 R is calculated as an average value of five porosities of coordinate values of 0, 0.05 R, 0.10 R, 0.15 R and 0.20 R.

The thickness of the partition wall 113 is defined as a crossing length of a line segment that crosses the partition wall 133 when the centers of gravity of adjacent cells 115 are connected by this ling segment in a cross-section perpendicular to the direction in which the cells 115 extend. The average thickness of the partition walls in a specific coordinate range is calculated as the average value of all the thicknesses of the partition walls that are at least partially included in the specific coordinate range.

The cell density in a specific coordinate range is a value obtained by dividing the number of cells that are at least partially included in the coordinate range by the area of one end surface in the specific coordinate range.

The shape of the cells in the cross-section perpendicular to the direction in which the cells extend 115 is not limited, but is preferably quadrangular, hexagonal, octagonal, or a combination thereof. Among these, quadrangles and hexagons are preferred. Such a cell shape reduces the pressure loss when exhaust gas is caused to flow through the honeycomb structure 110, resulting in excellent purification performance of the catalyst. A hexagonal shape is particularly preferable from the viewpoint that it is easy to achieve both structural strength and heat generation uniformity.

The cells 115 may extend from one end surface 116 to the other end surface 118. In that case, the cells 115 may have the first cells sealed on one end surface 116 and having openings on the other end surface 118, and the second cells having openings on one end surface 116 and sealed on the other end surface 118, which are alternately arranged adjacent to each other with the partition walls 113 interposed therebetween.

Providing the honeycomb structure 110 with an outer peripheral wall 114 is useful from the viewpoint of ensuring the structural strength of the honeycomb structure 110 and suppressing leakage of the fluid flowing through the cells 115 from the outer peripheral side surface. In this regard, the thickness of the outer peripheral wall 114 is preferably 0.1 mm or more, more preferably 0.15 mm or more, and even more preferably 0.2 mm or more. However, if the outer peripheral wall 114 is too thick, the strength becomes too high, and the strength balance with the partition walls 113 is lost, resulting in a decrease in thermal shock resistance. Therefore, the thickness of the outer peripheral wall 114 is preferably 1.0 mm or less, more preferably 0.7 mm or less, and even more preferably 0.5 mm or less. Here, the thickness of the outer peripheral wall 114 is measured by observing the location of the outer peripheral wall 114 whose thickness is to be measured in the cross-section perpendicular to the direction in which the cells 115 extend, and defined as the thickness in the direction normal to the tangential line of the outer surface of the outer peripheral wall 114 at the measurement location.

On the outer peripheral wall 114, by arranging electrode layers 112a and 112b having a volume resistivity lower than that of the outer peripheral wall 114, the current spreads easily in the circumferential direction of the honeycomb structure 110 and in the direction in which the cells 115 extend, which enables to improve the heat generation uniformity of the honeycomb structure 110. In the cross-section perpendicular to the cells 115, an angle θ (0°≤θ≤180°) formed by two line segments extending from the center of each of the pair of electrode layers 112a and 112b in the circumferential direction to the central axis (center of gravity O) of the honeycomb structure 110 is preferably 150°≤θ≤180°, more preferably 160°≤θ≤180°, even more preferably 170°≤θ≤180°, and 180° is most preferred.

Although there are no particular restrictions on the areas where the electrode layers 112a and 112b are formed, from the viewpoint of improving the heat generation uniformity of the honeycomb structure 110, it is preferable that the electrode layers 112a and 112b extend on the outer surface of the outer peripheral wall 114 in a strip shape, in the circumferential direction of the honeycomb structure 110 and in the direction in which the cells 115 extend. Specifically, in the cross-section perpendicular to the direction in which the cells 115 extend, a central angle a formed by two line segments connecting both side ends of the electrode layers 112a and 112b in the circumferential direction with the central axis (the center of gravity O) is preferably 30° or more, more preferably 40° or more, and even more preferably 60° or more, from the viewpoint of spreading the current in the circumferential direction to improve heat generation uniformity. However, if the central angle a is too large, less current passes through the interior of the honeycomb structure 110 and more current passes near the outer peripheral wall 114. Therefore, from the viewpoint of heat generation uniformity of the honeycomb structure 110, the central angle a is preferably 140° or less, more preferably 130° or less, and even more preferably 120° or less. In addition, it is desirable that the each of the electrode layers 112a and 112b extend over 80% or more, preferably over 90% or more, and more preferably over the entire length of the length between both end surfaces of the honeycomb structure 110. The electrode layers 112a and 112b may be composed of a single layer, or may have a laminated structure in which multiple layers are laminated.

The thickness of the electrode layers 112a and 112b is preferably 0.01 to 5 mm, more preferably 0.01 to 3 mm. Heat generation uniformity can be increased by setting it to such a range. When the thickness of the electrode layers 112a and 112b is 0.01 mm or more, the electrical resistance is appropriately controlled, and heat can be generated more uniformly. When the thickness of the electrode layers 112a and 112b is 5 mm or less, the risk of breakage during canning is reduced. The thickness of the electrode layers 112a and 112b is measured by observing the location of the electrode layers 112a and 112b whose thickness is to be measured in the cross-section perpendicular to the direction in which the cells 115 extend, and defined as the thickness in the direction normal to the tangential line of the outer surface of the electrode layers 112a and 112b at the measurement location.

By making the volume resistivity of the electrode layers 112a and 112b lower than the volume resistivity of the partition walls 113 and the outer peripheral wall 114, electricity tends to flow preferentially through the electrode layers 112a and 112b, and electricity tends to spread in the circumferential direction of the honeycomb structure 110 and in the direction in which the cells 115 extend when energized. The volume resistivity of the electrode layers 112a and 112b is preferably 1/10 or less, more preferably 1/20 or less, and even more preferably 1/30 or less of the volume resistivity of the partition walls 113 and the outer peripheral wall 114. However, if the difference in volume resistivity between them becomes too large, the current concentrates between the ends of the opposing electrode layers 112a and 112b, and the heat generation of the honeycomb structure 110 is biased. Therefore, the volume resistivity of the electrode layers 112a and 112b is preferably 1/200 or more, more preferably 1/150 or more, and even more preferably 1/100 or more of the volume resistivity of the partition walls 113 and the outer peripheral wall 114. In the present invention, the volume resistivity of the electrode layer, the partition wall and the outer peripheral wall is the value measured at 25° C. by a four-terminal method.

The material of the electrode layers 112a and 112b is not limited, but a composite material (cermet) of metal and ceramics (especially conductive ceramics) can be used. Examples of metals include single metals such as Cr, Fe, Co, Ni, Si, and Ti, and alloys containing at least one metal selected from these metals. Examples of ceramics include, but are not limited to, silicon carbide (SiC), as well as metal compounds such as metal silicides such as tantalum silicide (TaSi₂) and chromium silicide (CrSi₂). Specific examples of composite materials (cermets) of metal and ceramics include composite materials of metallic silicon and silicon carbide; composite materials of metal silicide (such as tantalum silicide and chromium silicide), metallic silicon and silicon carbide; and furthermore, from the viewpoint of reducing thermal expansion, composite materials in which one or more kinds of insulating ceramics such as alumina, mullite, zirconia, cordierite, silicon nitride and aluminum nitride are added to one or more of the above metals can be mentioned. As the material of the electrode layers 112a and 112b, among the various metals and ceramics described above, a composite material of metal silicide (such as tantalum silicide or chromium silicide), metallic silicon and silicon carbide, for which the partition walls and the outer peripheral wall can be fired at the same time, is preferable for the reason that it can contribute to simplification of the manufacturing process.

In one embodiment, when the following thermal shock resistance test is performed, the honeycomb structure has a crack initiation temperature of 900° C. or higher, preferably 950° C. or higher, more preferably 1050° C. or higher, and it may be 900 to 1100° C.

The thermal shock resistance test is performed according to the following procedure. The honeycomb structure is housed (canned) in a metal case of a propane gas burner tester. Then, the gas (combustion gas) heated by the propane gas burner is supplied into the metal case, and the temperature condition of the heated gas flowing into the metal case (inlet gas temperature condition) and passing through the honeycomb structure is set as follows. First, the temperature is raised to a specified temperature in 10 minutes, held at the specified temperature for 5 minutes, then cooled to 100° C. in 3 minutes, and held at 100° C. for 10 minutes. Such a series of operations of raising, holding, cooling, and holding temperature is called “heating and cooling operation”. After that, the honeycomb structure is cooled to room temperature, and the presence of cracks in the honeycomb structure is checked with a microscope. If no cracks are found, the sample is deemed as passed the thermal shock resistance test, and if any cracks are found, the sample is deemed as failed the thermal shock test. Then, the specified temperature is raised from 800° C. by 50° C. each time, and the above “heating and cooling operation” is repeated. The specified temperature is increased by 50° C. each time until cracks occur in the honeycomb structure.

### (1-2. Metal Terminal)

A metal terminal 130 is directly or indirectly joined to the respective outer surfaces of the pair of electrode layers 112a and 112b. When a voltage is applied to the honeycomb structure 110 through the metal terminals 130, heat can be generated in the honeycomb structure 110 by Joule heat. Therefore, the honeycomb structure 110 can also be suitably used as a heater. This makes it possible to improve heat generation uniformity of the honeycomb structure 110. The applied voltage is preferably 12 to 900 V, more preferably 48 to 600 V, but the applied voltage can be changed as appropriate.

Although the metal terminals 130 and the electrode layers 112a and 112b may be directly joined, for the purpose of alleviating the difference in thermal expansion between the electrode layers 112a and 112b and the metal terminals 130 and of improving the joining reliability of the metal terminals 130, they may be joined through one or two or more underlying layers 120. Therefore, in a preferred embodiment, the honeycomb structure 110 has a pair of electrode layers 112a and 112b arranged on the outer peripheral wall 114 so as to face each other with the central axis (the center of gravity O) of the honeycomb structure 110 interposed therebetween, and one or more metal terminals 130 are joined to each of the electrode layers 112a and 112b via the underlying layer 120.

From the viewpoint of improving the joining reliability, it is preferable to decrease the coefficient of thermal expansion stepwise in the order of metal terminal 130→(underlying layer 120)→electrode layers 112a and 112b→outer peripheral wall 114. In addition, the “coefficient of thermal expansion” here means the coefficient of linear expansion measured according to JIS R1618:2002 when changing from 25° C. to 1000° C.

The material of the metal terminal 130 is not particularly limited as long as it is metal, and a single metal, an alloy, or the like can be used. However, from the viewpoint of corrosion resistance, volume resistivity and coefficient of linear expansion, for example, an alloy containing at least one selected from the group consisting of Cr, Fe, Co, Ni and Ti is preferred, and stainless steel and Fe-Ni alloys are more preferred. The shape and size of the metal terminal 130 are not particularly limited, and can be appropriately designed according to the size, the current-carrying performance, and the like of the honeycomb structure 110.

The material of the underlying layer 120 is not limited, but a composite material (cermet) of metal and ceramics (especially conductive ceramics) can be used. The coefficient of thermal expansion of the underlying layer 120 can be controlled by adjusting the compounding ratio of metal and ceramics, for example.

The underlayer 120 preferably contains one or more metals selected from Ni-based alloys, Fe-based alloys, Ti-based alloys, Co-based alloys, metallic silicon, and Cr, although not limited thereto.

The underlayer 120 preferably contains one or more ceramics selected from oxide ceramics such as alumina, mullite, zirconia, glass and cordierite, and non-oxide ceramics such as silicon carbide, silicon nitride and aluminum nitride, although not limited thereto.

Although the thickness of the underlayer 120 is not particularly limited, it is preferably 0.1 to 1.5 mm, more preferably 0.3 to 0.5 mm, from the viewpoint of suppressing cracks. The thickness of the underlying layer 120 is measured by observing the location of the underlying layer 120 whose thickness is to be measured in the cross-section perpendicular to the direction in which the cells extend, and defined as the thickness in the direction normal to the tangential line of the outer surface of the underlying layer 120 at the measurement location.

The method of joining the metal terminals 130 with the electrode layers 112a, 112b or with the underlying layer 120 is not particularly limited, but examples thereof include thermal spraying, welding and brazing.

### (2. Exhaust Gas Purification Device)

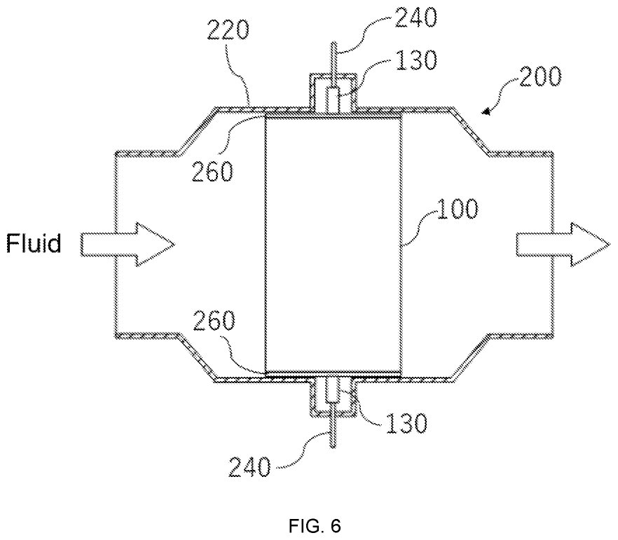

The electrically heated carrier according to an embodiment of the present invention can be used in an exhaust gas purification device. Referring to FIG. 6, the exhaust gas purification device 200 comprises an electrically heated carrier 100 and a tubular metal pipe 220 that accommodates the electrically heated carrier 100. An electrical wire 240 for power supply can be connected to the metal terminals 130 of the electrically heated carrier 100. Although the metal forming the metal pipe 220 is not limited, various types of stainless steel including chromium-based stainless steel can be used. By using these metals, an exhaust gas purification device having high heat resistance and corrosion resistance can be obtained.

In the exhaust gas purification device 200, the electrically heated carrier 100 can be installed on the way of the flow path of a fluid such as automobile exhaust gas. The electrically heated carrier 100 can be fixed in the metal pipe 220 by, for example, push-canning in which it is pushed into the metal pipe 220 and fitted so that the direction in which the cells extend and the direction in which the metal pipe 220 extend match. A holding material (mat) 260 is preferably provided between the metal pipe 220 and the electrically heated carrier 100. The material constituting the holding material (mat) 260 is not limited, but ceramics such as alumina fiber, mullite fiber, or ceramic fiber containing alumina-silica as a main component can be used.

### (3. Manufacturing Method)

Next, a method for manufacturing an electrically heated carrier according to one embodiment of the present invention will be exemplified. The electrically heated carrier can be manufactured by a manufacturing method comprising a step 1 of obtaining a honeycomb formed body; a step 2 of obtaining an unfired honeycomb structure with electrode layer forming paste; a step 3 of obtaining a honeycomb structure by firing the unfired honeycomb structure with the electrode layer forming paste; and a step 4 of joining metal terminals to the electrode layers.

### (Step 1)

Step 1 is a step of preparing a honeycomb formed body, which is a precursor of a honeycomb structure. The honeycomb formed body can be prepared according to a method for preparing a honeycomb formed body in a known method for manufacturing a honeycomb structure. For example, first, metallic silicon powder (metallic silicon), a binder, a surfactant, a pore-forming material, water, and the like are added to silicon carbide powder (silicon carbide) to prepare a forming raw material. It is preferable that the mass of the metallic silicon powder be 10 to 40% by mass with respect to the sum of the mass of the silicon carbide powder and the mass of the metallic silicon powder. The average particle size of silicon carbide particles in the silicon carbide powder is preferably 3 to 50 μm, more preferably 3 to 40 μm. The average particle size of the metallic silicon particles in the metallic silicon powder is preferably 2 to 35 μm. The average particle size of silicon carbide particles and metallic silicon particles refers to the volume-based arithmetic mean size when the frequency distribution of particle sizes is measured by a laser diffraction method. The silicon carbide particles are fine particles of silicon carbide that constitute the silicon carbide powder, and the metallic silicon particles are fine particles of metallic silicon that constitute the metallic silicon powder. It should be noted that this is the composition of a forming raw material when the material of the honeycomb structure is a silicon-silicon carbide composite material, and when the material of the honeycomb structure is silicon carbide, metallic silicon is not added.

As the binder, methylcellulose, hydroxypropylmethylcellulose, hydroxypropoxylcellulose, hydroxyethylcellulose, carboxymethylcellulose, polyvinyl alcohol and the like can be mentioned. Among these, it is preferable to use methyl cellulose and hydroxypropoxyl cellulose in combination. The amount of the binder is preferably 2.0 to 10.0 parts by mass provided that the total mass of the silicon carbide powder and the metallic silicon powder is 100 parts by mass.

As the surfactant, ethylene glycol, dextrin, fatty acid soap, polyalcohol, and the like can be used. One type of them can be used alone, and two or more types can be used in combination. The amount of the surfactant is preferably 0.1 to 2.0 parts by mass provided that the total mass of the silicon carbide powder and the metallic silicon powder is 100 parts by mass.

The pore-forming material is not particularly limited as long as it forms pores after firing, and examples thereof include graphite, starch, foamed resin, water absorbent resin, silica gel, and the like. The amount of the pore-forming material is preferably 0.5 to 10.0 parts by mass provided that the total mass of the silicon carbide powder and the metallic silicon powder is 100 parts by mass. The average particle size of the pore-forming material is preferably 10 to 30 μm. The average particle size of the pore-forming material refers to the volume-based arithmetic mean size when the frequency distribution of particle sizes is measured by a laser diffraction method. When the pore-forming material is a water absorbent resin, the average particle size of the pore-forming material means the average particle size after water absorption.

The content of water is preferably 20 to 60 parts by mass provided that the total mass of the silicon carbide powder and the metallic silicon powder is 100 parts by mass.

Next, after kneading the obtained forming raw material and forming a green body, the green body is extrusion molded to prepare a pillar-shaped honeycomb formed body having an outer peripheral wall and partition walls. For extrusion molding, a die having a desired overall shape, cell shape, partition wall thickness, cell density, and the like can be used. Next, it is preferable to dry the obtained honeycomb formed body. When the length of the honeycomb formed body in the central axis direction is not the desired length, both ends of the honeycomb formed body can be cut to obtain the desired length. The dried honeycomb formed body is called a honeycomb dried body.

As a method of increasing the porosity from the central portion toward the outer peripheral portion, two or more types of green bodies with different addition amounts of pore-forming material are prepared when preparing the above-mentioned green body. For example, the green bodies are concentrically stacked and wound to create a green body with different addition amounts of the pore-forming material between the central portion and the outer peripheral portion, and extrusion molding is performed. As a method for adjusting the porosity, for example, the porosity at the time of firing can be adjusted by adjusting the amount of the pore-forming material added when forming the silicon-silicon carbide composite material.

As a modification of step 1, the honeycomb formed body may be once fired. That is, in this modification, a honeycomb formed body is fired to prepare a honeycomb fired body, and step 2 is performed on the honeycomb fired body.

### (Step 2)

Step 2 is a step of applying an electrode layer forming paste to the side surface of the honeycomb formed body to obtain an unfired honeycomb structure with the electrode layer forming paste. The electrode layer forming paste can be prepared by appropriately adding various additives to raw material powders (metal powder, ceramic powder, and the like) that have been compounded according to the required properties of the electrode layer, and kneading the mixture. Although the average particle size of the raw material powder is not limited, it is preferably, for example, 5 to 50 μm, more preferably 10 to 30 μm. The average particle size of the raw material powder refers to the volume-based arithmetic mean size when the frequency distribution of particle sizes is measured by a laser diffraction method.

Next, the electrode layer forming paste thus obtained is applied to desired portions of the side surface of the formed honeycomb body (typically a honeycomb dried body) to obtain an unfired honeycomb structure with the electrode layer forming paste. The method of preparing the electrode layer forming paste and the method of applying the electrode layer forming paste to the honeycomb formed body can be carried out according to a known method for manufacturing a honeycomb structure. However, in order to make the volume resistivity of the electrode layers lower than that of the outer peripheral wall and the partition walls, the metal content ratio can be made higher than that of the outer peripheral wall and the partition walls, or the particle size of the metal particles in the raw material powder can be reduced.

### (Step 3)

Step 3 is a step of firing the unfired honeycomb structure with the electrode layer forming paste to obtain a honeycomb structure. Before firing, the unfired honeycomb structure with the electrode layer forming paste may be dried. Moreover, before firing, degreasing may be performed to remove the binder and the like. The method of degreasing and firing is not particularly limited, and firing can be performed using an electric furnace, a gas furnace, or the like. As the firing conditions, although they depend on the material of the honeycomb structure, it is preferable to heat at 1400 to 1500° C. for 1 to 20 hours in an inert atmosphere such as nitrogen or argon.

### (Step 4)

Step 4 is a step of joining metal terminals to the electrode layers. The joining method is not particularly limited, but examples thereof include thermal spraying, welding and brazing. From the viewpoint of improving the joining reliability between the electrode layer and the metal terminal, the underlying layer may be formed by a method such as thermal spraying.

### EXAMPLES

The following Examples are provided for a better understanding of the invention and its advantages, but are not intended to limit the scope of the invention.

### Comparative Example 1

### (1. Preparation of Cylindrical Green Body)

A ceramic raw material was prepared by mixing silicon carbide (SiC) powder and metallic silicon (Si) powder at a mass ratio of 80:20. Then, hydroxypropylmethyl cellulose as a binder, a water absorbent resin as a pore-forming material were added to the ceramic raw material, and water was added to obtain a forming raw material. Then, the forming raw material was kneaded by a vacuum kneader to prepare a cylindrical green body. The amount of the binder was 7 parts by mass provided that the total of silicon carbide (SiC) powder and metallic silicon (Si) powder was 100 parts by mass. The amount of the pore-forming material was 3 parts by mass provided that the total of silicon carbide (SiC) powder and metallic silicon (Si) powder was 100 parts by mass. The amount of water was 42 parts by mass provided that the total of silicon carbide (SiC) powder and metallic silicon (Si) powder was 100 parts by mass. The silicon carbide powder had an average particle size of 20 μm, and the metallic silicon powder had an average particle size of 6 μm. In addition, the average particle size of the pore-forming material was 20 μm. The average particle size of the silicon carbide powder, metallic silicon powder and pore-forming material refers to the volume-based arithmetic mean size when the frequency distribution of particle sizes is measured by a laser diffraction method.

### (2. Preparation of Honeycomb Dried Body)

The obtained cylindrical green body was formed using an extruder having a predetermined die structure to obtain a cylindrical honeycomb formed body in which each cell had a hexagonal shape in a cross-section perpendicular to the direction in which the cells extend. This honeycomb formed body was dried by high-frequency dielectric heating, then dried at 120 ° C. for 2 hours using a hot gas dryer, and both end surfaces were cut by a predetermined amount to prepare a honeycomb dried body.

### (3. Preparation of Electrode Layer Forming Paste)

Metallic silicon (Si) powder, silicon carbide (SiC) powder, methyl cellulose, glycerin, and water were mixed with a planetary centrifugal mixer to prepare an electrode layer forming paste. The Si powder and the SiC powder were blended in a volume ratio of Si powder:SiC powder=40 60. Further, provided that the total of Si powder and SiC powder was 100 parts by mass, methyl cellulose was 0.5 parts by mass, glycerin was 10 parts by mass, and water was 38 parts by mass. The average particle size of the metallic silicon powder was 6 μm. The silicon carbide powder had an average particle size of 35 μm. These average particle sizes refer to volume-based arithmetic mean sizes when the frequency distribution of particle sizes is measured by a laser diffraction method.

### (4. Application of Electrode Layer Forming Paste)

The above-mentioned electrode layer forming paste was applied by a curved surface printer on the outer surface of the outer peripheral wall of the above-mentioned honeycomb dried body at two locations so as to face each other across the central axis. Each application portion was formed in a strip shape over the entire length between both end surfaces of the honeycomb dried body (angle θ=180°, central angle α=90°.

### (5. Firing)

After drying the honeycomb structure with the electrode layer forming paste at 120° C., it was degreased at 550° C. for 3 hours in the air atmosphere. Next, the degreased honeycomb structure with the electrode layer forming paste was fired and then oxidization treatment was performed to obtain a cylindrical honeycomb structure with a height of 65 mm and a diameter of 80 mm. The firing was performed in an argon atmosphere at 1450° C. for 2 hours.

### Example 1

In addition to the green body (green body 1) used in Comparative Example 1, a green body (green body 2) with a different addition amount of the pore-forming material was prepared. The green body 2 was wound around the green body 1 with the green body 1 on the inside to prepare a cylindrical green body with different addition amounts of the pore-forming material between the central portion and the outer peripheral portion so that the porosity of the honeycomb structure switched from 40% to 60% at the coordinate value of 0.30 R. A honeycomb structure was prepared under the same manufacturing conditions as in Comparative Example 1, except that this cylindrical green body was extruded.

### Example 2

In addition to the green body (green body 1) used in Comparative Example 1, a green body (green body 2) with a different addition amount of the pore-forming material was prepared. The green body 2 was wound around the green body 1 to prepare a cylindrical green body with different addition amounts of the pore-forming material between the central portion and the outer peripheral portion so that the porosity switched from 40% to 60% at the coordinate value of 0.375 R. A honeycomb structure was prepared under the same manufacturing conditions as in Example 1, except that this cylindrical green body was extruded.

### Example 3

In addition to the green body (green body 1) used in Comparative Example 1, a green body (green body 2) with a different addition amount of the pore-forming material was prepared. The green body 2 was wound around the green body 1 to prepare a cylindrical green body with different addition amounts of the pore-forming material between the central portion and the outer peripheral portion so that the porosity switched from 40% to 60% at the coordinate value of 0.60 R. A honeycomb structure was prepared under the same manufacturing conditions as in Example 1, except that this cylindrical green body was extruded.

### Example 4

In addition to the green body (green body 1) used in Comparative Example 1, a green body (green body 2) with a different addition amount of the pore-forming material was prepared. The green body 2 was wound around the green body 1 to prepare a cylindrical green body with different addition amounts of the pore-forming material between the central portion and the outer peripheral portion so that the porosity switched from 40% to 60% at the coordinate value of 0.75 R. A honeycomb structure was prepared under the same manufacturing conditions as in Example 1, except that this cylindrical green body was extruded.

### Example 5

In addition to the green body (green body 1) used in Comparative Example 1, a green body (green body 2) with a different addition amount of the pore-forming material was prepared. The green body 2 was wound around the green body 1 to prepare a cylindrical green body with different addition amounts of the pore-forming material between the central portion and the outer peripheral portion so that the porosity switched from 40% to 60% at the coordinate value of 0.90 R. A honeycomb structure was prepared under the same manufacturing conditions as in Example 1, except that this cylindrical green body was extruded.

### Example 6

In addition to the green body (green body 1) used in Comparative Example 1, a green body (green body 3) with a different addition amount of the pore-forming material was prepared. The green body 3 was wound around the green body 1 to prepare a cylindrical green body with different addition amounts of the pore-forming material between the central portion and the outer peripheral portion so that the porosity switched from 40% to 44% at the coordinate value of 0.60 R. A honeycomb structure was prepared under the same manufacturing conditions as in Example 1, except that this cylindrical green body was extruded.

### Example 7

In addition to the green body (green body 1) used in Comparative Example 1, a green body (green body 4) with a different addition amount of the pore-forming material was prepared. The green body 4 was wound around the green body 1 to prepare a cylindrical green body with different addition amounts of the pore-forming material between the central portion and the outer peripheral portion so that the porosity switched from 40% to 70% at the coordinate value of 0.60 R. A honeycomb structure was prepared under the same manufacturing conditions as in Example 1, except that this cylindrical green body was extruded.

### Example 8

In addition to the green body (green body 1) used in Comparative Example 1, a green body (green body 5) with a different addition amount of the pore-forming material was prepared. The green body 5 was wound around the green body 1 to prepare a cylindrical green body with different addition amounts of the pore-forming material between the central portion and the outer peripheral portion so that the porosity switched from 40% to 80% at the coordinate value of 0.60 R. A honeycomb structure was prepared under the same manufacturing conditions as in Example 1, except that this cylindrical green body was extruded.

### Example 9

In addition to the green body (green body 1) used in Comparative Example 1, a green body (green body 6) with a different addition amount of the pore-forming material was prepared. The green body 1 was wound around the green body 6 to prepare a cylindrical green body with different addition amounts of the pore-forming material between the central portion and the outer peripheral portion so that the porosity switched from 20% to 40% at the coordinate value of 0.60 R. A honeycomb structure was prepared under the same manufacturing conditions as in Example 1, except that this cylindrical green body was extruded.

### Example 10

In addition to the green body (green body 6) used in Example 9, a green body (green body 7) with a different addition amount of the pore-forming material was prepared. The green body 7 was wound around the green body 6 to prepare a cylindrical green body with different addition amounts of the pore-forming material between the central portion and the outer peripheral portion so that the porosity switched from 20% to 50% at the coordinate value of 0.60 R. A honeycomb structure was prepared under the same manufacturing conditions as in Example 1, except that this cylindrical green body was extruded.

### Example 11

The green body 1, the green body 2, and the green body 7 were prepared. The green body 7 and the green body 2 were wound in this order around the green body 1 to prepare a cylindrical green body with different addition amounts of the pore-forming material between the central portion and the outer peripheral portion so that the porosity switched from 40% to 50% at the coordinate value of 0.40 R and switched from 50% to 60% at the coordinate value of 0.60 R. A honeycomb structure was prepared under the same manufacturing conditions as in Example 1, except that this cylindrical green body was extruded.

### Example 12

In addition to the green body 1, the green body 2, and the green body 7 used in Example 11, green bodies (green body 8 and green body 9) with different addition amounts of the pore-forming material were prepared. The green body 8, the green body 7, the green body 9, and the green body 2 were wound in this order around the green body 1 to prepare a cylindrical green body with different addition amounts of the pore-forming material between the central portion and the outer peripheral portion so that the porosity switched from 40% to 45% at the coordinate value of 0.20 R, from 45% to 50% at the coordinate value of 0.40 R, from 50% to 55% at the coordinate value of 0.60 R, and from 55% to 60% at the coordinate value of 0.80 R. A honeycomb structure was prepared under the same manufacturing conditions as in Example 1, except that this cylindrical green body was extruded.

### Characteristic Evaluation

The honeycomb structures obtained under the above manufacturing conditions were evaluated for the following characteristics. In addition, a necessary number of honeycomb structures were prepared for the characteristic evaluation.

### (1. Porosity Measurement)

Samples for measuring the porosity of each coordinate value in the radial direction (coordinate value from 0 to 1.00 R, every coordinate difference of 0.05 R) were taken from the honeycomb structure by the method described above, and the measurement results shown in Table 1-1 were obtained. Scanning electron microscopy (SEM) was used to measure the porosity.

TABLE 1-1

| | Porosity (%) for each coordinate value (original data) | | | | | | | | | | |
|---|---|---|---|---|---|---|---|---|---|---|---|
| | 0 | 0.05 R | 0.10 R | 0.15 R | 0.20 R | 0.25 R | 0.30 R | 0.35 R | 0.40 R | 0.45 R | 0.50 R |
| Comparative | 40 | 40 | 40 | 40 | 40 | 40 | 40 | 40 | 40 | 40 | 10 |
| Example 1 | | | | | | | | | | | |
| Example 1 | 40 | 40 | 40 | 40 | 40 | 40 | 60 | 60 | 60 | 60 | 60 |
| Example 2 | 40 | 40 | 40 | 40 | 40 | 40 | 40 | 40 | 60 | 60 | 60 |
| Example 3 | 40 | 40 | 40 | 40 | 40 | 40 | 40 | 40 | 40 | 40 | 40 |
| Example 4 | 40 | 40 | 40 | 40 | 40 | 40 | 40 | 40 | 40 | 40 | 40 |
| Example 5 | 40 | 40 | 40 | 40 | 40 | 40 | 40 | 40 | 40 | 40 | 40 |
| Example 6 | 40 | 40 | 40 | 40 | 40 | 40 | 40 | 40 | 40 | 40 | 40 |
| Example 7 | 40 | 40 | 40 | 40 | 40 | 40 | 40 | 40 | 40 | 40 | 40 |
| Example 8 | 40 | 40 | 40 | 40 | 40 | 40 | 40 | 40 | 40 | 40 | 40 |
| Exemple 9 | 20 | 20 | 20 | 20 | 20 | 20 | 20 | 20 | 20 | 20 | 20 |
| Example 10 | 20 | 20 | 20 | 20 | 20 | 20 | 20 | 20 | 20 | 20 | 20 |
| Example 11 | 40 | 40 | 40 | 40 | 40 | 40 | 40 | 40 | 50 | 50 | 50 |
| Example 12 | 40 | 40 | 40 | 40 | 45 | 45 | 45 | 45 | 50 | 50 | 50 |

| | Porosity (%) for each coordinate value (original data) | | | | | | | | | |
|---|---|---|---|---|---|---|---|---|---|---|
| | 0.55 R | 0.60 R | 0.65 R | 0.70 R | 0.75 R | 0.80 R | 0.85 R | 0.90 R | 0.95 R | 1.00 R |
| Comparative | 40 | 40 | 40 | 40 | 40 | 40 | 40 | 40 | 40 | 40 |
| Example 1 | | | | | | | | | | |
| Example 1 | 60 | 60 | 60 | 60 | 60 | 60 | 60 | 60 | 60 | 60 |
| Example 2 | 60 | 60 | 60 | 60 | 60 | 60 | 60 | 60 | 60 | 60 |
| Example 3 | 40 | 60 | 60 | 60 | 60 | 60 | 60 | 60 | 60 | 60 |
| Example 4 | 40 | 40 | 40 | 40 | 60 | 60 | 60 | 60 | 60 | 60 |
| Example 5 | 40 | 40 | 40 | 40 | 40 | 40 | 40 | 60 | 60 | 60 |
| Example 6 | 40 | 44 | 44 | 44 | 44 | 44 | 44 | 44 | 44 | 44 |
| Example 7 | 40 | 70 | 70 | 70 | 70 | 70 | 70 | 70 | 70 | 70 |
| Example 8 | 40 | 80 | 80 | 80 | 80 | 80 | 80 | 80 | 80 | 80 |
| Exemple 9 | 20 | 40 | 40 | 40 | 40 | 40 | 40 | 40 | 40 | 40 |
| Example 10 | 20 | 50 | 50 | 50 | 50 | 50 | 50 | 50 | 50 | 50 |
| Example 11 | 50 | 60 | 60 | 60 | 60 | 60 | 60 | 60 | 60 | 60 |
| Example 12 | 50 | 55 | 55 | 55 | 55 | 60 | 60 | 60 | 60 | 60 |

Based on the above measurement results, the following values were obtained. The results are shown in Table 1-2.
Average value P_{1A} of the porosity of the partition walls (%) in the range of coordinate values of 0 to 0.50 R
Average value P_{2A} of the porosity of the partition walls (%) in the range of coordinate values of 0.50 R to 1.00 R
Ratio of the porosity of the partition walls at the coordinate value of 0.35 R to the porosity of the partition walls at the coordinate value of 0 (ratio 0.35 R/0)
Ratio of the porosity of the partition walls at the coordinate value of 0.75 R to the porosity of the partition walls at the coordinate value of 0.35 R (ratio 0.75 R/0.35 R)
Ratio of the porosity of the partition walls at the coordinate value of 1.00 R to the porosity of the partition walls at the coordinate value of 0.75 R (ratio 1.00 R/0.75 R)
Average value P_{1B} of the porosity (%) of the partition walls in the range of coordinate values of 0 to 0.35 R
Average value P_{2B} of the porosity (%) of the partition walls in the range of coordinate values of 0.35 R to 0.75 R
Average value P_{3B} of the porosity (%) of the partition walls in the range of coordinate values of 0.75 R to 1.00 R
Average value P_{1C} of the porosity (%) of the partition walls in the range of coordinate values of 0 to 0.20 R
Average value P_{2C} of the porosity (%) of the partition walls in the range of coordinate values of 0.20 R to 0.40 R
Average value P_{3C} of porosity (%) of the partition walls in the range of coordinate values of 0.40 R to 0.60 R
Average value P_{4C} of the porosity (%) of the partition walls in the range of coordinate values of 0.60 R to 0.80 R
Average value P_{5C} of the porosity (%) of the partition walls in the range of coordinate values of 0.80 R to 1.00 R

Further, P_{2A}/P_{1A}, P_{2B}/P_{1B}, P_{3B}/P_{2B}, P_{3B}/P_{1B}, P_{2C}/P_{1C}, P_{3C}/P_{2C}, P_{4C}/P_{3C}, P_{5C}/P_{4C}, and P_{5C}/P_{1C} were calculated based on the results shown in Table 1-2, respectively . The results are shown in Tables 1-3.

TABLE 1-2

| | P_{1A} | P_{2A} | Ratio | Ratio | Ratio | P_{1B} | P_{2B} | P_{3B} | P_{1C} | P_{2C} | P_{3C} | P_{4C} | P_{5C} |
|---|---|---|---|---|---|---|---|---|---|---|---|---|---|
| | (%) | (%) | 0.35R/0 | 0.75R/0.35R | 1.00R/0.75R | (%) | (%) | (%) | (%) | (%) | (%) | (%) | (%) |
| Comparative | 40.00 | 40.00 | 1.00 | 1.00 | 1.00 | 40.0 | 40.0 | 40.0 | 40.0 | 40.0 | 40.0 | 40.0 | 40.0 |
| Example 1 | | | | | | | | | | | | | |
| Example 1 | 49.09 | 60.00 | 1.50 | 1.00 | 1.00 | 45.0 | 60.0 | 60.0 | 40.0 | 52.0 | 60.0 | 60.0 | 60.0 |
| Example 2 | 45.45 | 60.00 | 1.00 | 1.50 | 1.00 | 40.0 | 57.8 | 60.0 | 40.0 | 44.0 | 60.0 | 60.0 | 60.0 |
| Example 3 | 40.00 | 56.36 | 1.00 | 1.50 | 1.00 | 40.0 | 48.9 | 60.0 | 40.0 | 40.0 | 44.0 | 60.0 | 60.0 |
| Example 4 | 40.00 | 50.91 | 1.00 | 1.50 | 1.00 | 40.0 | 42.2 | 60.0 | 40.0 | 40.0 | 40.0 | 48.0 | 60.0 |
| Example 5 | 40.00 | 45.45 | 1.00 | 1.00 | 1.50 | 40.0 | 40.0 | 50.0 | 40.0 | 40.0 | 40.0 | 40.0 | 52.0 |
| Example 6 | 40.00 | 43.27 | 1.00 | 1.10 | 1.00 | 40.0 | 41.8 | 44.0 | 40.0 | 40.0 | 40.8 | 44.0 | 44.0 |
| Example 7 | 40.00 | 64.55 | 1.00 | 1.75 | 1.00 | 40.0 | 53.3 | 70.0 | 40.0 | 40.0 | 46.0 | 70.0 | 70.0 |
| Example 8 | 40.00 | 72.73 | 1.00 | 2.00 | 1.00 | 40.0 | 57.8 | 80.0 | 40.0 | 40.0 | 48.0 | 80.0 | 80.0 |
| Example 9 | 20.00 | 36.36 | 1.00 | 2.00 | 1.00 | 20.0 | 28.9 | 40.0 | 20.0 | 20.0 | 24.0 | 40.0 | 40.0 |
| Example 10 | 20.00 | 44.55 | 1.00 | 2.50 | 1.00 | 20.0 | 33.3 | 50.0 | 20.0 | 20.0 | 26.0 | 50.0 | 50.0 |
| Example 11 | 42.73 | 58.18 | 1.00 | 1.50 | 1.00 | 40.0 | 53.3 | 60.0 | 40.0 | 42.0 | 52.0 | 60.0 | 60.0 |
| Example 12 | 44.55 | 56.36 | 1.13 | 1.22 | 1.09 | 42.5 | 51.7 | 59.2 | 41.0 | 46.0 | 51.0 | 56.0 | 60.0 |

### (2. Average Thickness of Partition Walls)

A cross-section perpendicular to the direction in which the cells extend of the honeycomb structure was cut out, and the thickness of the partition wall at an arbitrary point was measured according to the definition described above. Because the thickness of the partition walls of the honeycomb structure was the same regardless of location due to the structure of the die used in the extrusion molding, the thickness of the partition wall at one location was regarded as the measured value. The results are shown in Tables 1-3.

### (3. Cell Density)

Due to the structure of the die used for the extrusion molding, the cell density was the same regardless of the location, so the value obtained by dividing the number of cells on one end surface (excluding the outer peripheral wall) of the honeycomb structure by the area of the end surface was regarded as the measured value. The results are shown in Tables 1-3.

### (4. Thermal Shock Resistance Test)

Using a propane gas burner tester equipped with a metal case for accommodating the honeycomb structure (sample) and a propane gas burner capable of supplying heating gas into the metal case, a thermal shock resistance test was performed on the honeycomb structures of Examples 1 to 12 and Comparative Example 1 shown in Table 1-3 below.

The heating gas was combustion gas generated by burning propane gas with a propane gas burner. Then, thermal shock resistance was evaluated by confirming whether or not cracks occurred in the honeycomb structure due to the thermal shock resistance test. Specifically, first, the honeycomb structure was housed (canned) in the metal case of the propane gas burner tester. Then, the gas (combustion gas) heated by the propane gas burner was supplied into the metal case so that the gas passed through the honeycomb structure.

The temperature condition of the heating gas flowing into the metal case (inlet gas temperature condition) was set as follows. First, the temperature was raised to a specified temperature in 10 minutes, held at the specified temperature for 5 minutes, then cooled to 100° C. in 3 minutes, and held at 100 ° C. for 10 minutes. Such a series of operations of raising, holding, cooling, and holding temperature is called “heating and cooling operation”. After that, the honeycomb structure was cooled to room temperature, and the presence of cracks in the honeycomb structure was checked with a microscope. If no cracks were found, the sample was deemed as passed the thermal shock resistance test, and if any cracks were found, the sample was deemed as failed the thermal shock test. Then, the specified temperature was raised from 800° C. by 50° C. each time, and the above “heating and cooling operation” was repeated. The specified temperature weas increased by 50° C. each time until cracks occur in the honeycomb structure. When the specified temperature becomes higher, the temperature in the central portion of the honeycomb structure becomes higher during the temperature rising, and the temperature difference in the radial direction is likely to occur, so that the generated thermal stress increases. In this thermal shock resistance test, cracks occurred on the side surfaces of all the honeycomb structures. In Table 1-3, the column “Thermal shock resistance test” shows the specified temperature when cracks occurred in the honeycomb structure in the thermal shock resistance test.

TABLE 1-3

| | | | | | | | | | | Average | | Thermal shock |
|---|---|---|---|---|---|---|---|---|---|---|---|---|
| | | | | | | | | | | thickness of | Cell | resistance |
| | P_{2A}/ | P_{2B}/ | P_{3B}/ | P_{3B}/ | P_{2C}/ | P_{3C}/ | P_{4C}/ | P_{5C}/ | P_{5C}/ | partition walls | density | test |
| | P_{1A} | P_{1B} | P_{2B} | P_{1B} | P_{1C} | P_{2C} | P_{3C} | P_{4C} | P_{1C} | (mm) | (cell/cm²) | (° C.) |
| Comparative | 1.00 | 1.00 | 1.00 | 1.00 | 1.00 | 1.00 | 1.00 | 1.00 | 1.00 | 0.13 | 93.00 | 900 |
| Example 1 | | | | | | | | | | | | |
| Example 1 | 1.22 | 1.33 | 1.00 | 1.33 | 1.30 | 1.15 | 1.00 | 1.00 | 1.50 | 0.13 | 93.00 | 950 |
| Example 2 | 1.32 | 1.44 | 1.04 | 1.50 | 1.10 | 1.36 | 1.00 | 1.00 | 1.50 | 0.13 | 93.00 | 950 |
| Example 3 | 1.41 | 1.22 | 1.23 | 1.50 | 1.00 | 1.10 | 1.36 | 1.00 | 1.50 | 0.13 | 93.00 | 1000 |
| Example 4 | 1.27 | 1.06 | 1.42 | 1.50 | 1.00 | 1.00 | 1.20 | 1.25 | 1.50 | 0.13 | 93.00 | 950 |
| Example 5 | 1.14 | 1.00 | 1.25 | 1.25 | 1.00 | 1.00 | 1.00 | 1.30 | 1.30 | 0.13 | 93.00 | 950 |
| Example 6 | 1.08 | 1.04 | 1.05 | 1.10 | 1.00 | 1.02 | 1.08 | 1.00 | 1.10 | 0.13 | 93.00 | 950 |
| Example 7 | 1.61 | 1.33 | 1.31 | 1.75 | 1.00 | 1.15 | 1.52 | 1.00 | 1.75 | 0.13 | 93.00 | 1000 |
| Example 8 | 1.82 | 1.44 | 1.38 | 2.00 | 1.00 | 1.20 | 1.67 | 1.00 | 2.00 | 0.13 | 93.00 | 1000 |
| Example 9 | 1.82 | 1.44 | 1.38 | 2.00 | 1.00 | 1.20 | 1.67 | 1.00 | 2.00 | 0.13 | 93.00 | 1000 |
| Example 10 | 2.23 | 1.67 | 1.50 | 2.50 | 1.00 | 1.30 | 1.92 | 1.00 | 2.50 | 0.13 | 93.00 | 1050 |
| Example 11 | 1.36 | 1.33 | 1.13 | 1.50 | 1.05 | 1.24 | 1.15 | 1.00 | 1.50 | 0.13 | 93.00 | 1050 |
| Example 12 | 1.27 | 1.22 | 1.15 | 1.39 | 1.12 | 1.11 | 1.10 | 1.07 | 1.46 | 0.13 | 93.00 | 1100 |

### (5. Discussion)

From the results of the thermal shock resistance test, in contrast to Comparative Example 1 in which there was no difference in the porosity of the partition walls in the radial direction, Examples 1 to 12, in which the porosity of the partition walls in the outer peripheral portion was larger than that in the central portion, it can be understood that the thermal shock resistance was improved. Furthermore, it can be understood that by optimizing the variation in the porosity in the radial direction, even with the same cell structure (average partition wall thickness, cell density), the thermal shock resistance was further improved.

### DESCRIPTION OF REFERENCE NUMERALS

100: Electrically heated carrier
110: Honeycomb structure
112a: Electrode layer
112b: Electrode layer
113: Partition wall
114: Outer peripheral wall
115: Cell
116: End surface
118: End surface
120: Underlying layer
130: Metal terminal
150: Sample
200: Exhaust gas purification device
220: Metal pipe
240: Electrical wire
260: Holding material (mat)

1. A honeycomb structure, comprising:
a honeycomb structure portion made of ceramics, comprising an outer peripheral wall; and partition walls disposed inside the outer peripheral wall and partitioning a plurality of cells which penetrate from one end surface to the other end surface and form flow paths; and
a pair of electrode layers provided on an outer surface of the outer peripheral wall so as to face each other across a central axis of the honeycomb structure;
wherein in a cross-section orthogonal to a direction in which the cells extend, assuming a coordinate value of a center of gravity O is 0, and a coordinate value of an inner peripheral surface of the outer peripheral wall is 1.00 R, an average value P_{1A} of a porosity (%) of the partition walls in a range of coordinate values of 0 to 0.50 R and an average value P_{2A} of a porosity (%) of the partition walls in a range of coordinate values of 0.50 R to 1.00 R satisfy a relationship of 1<P_{2A}/P_{1A}.

2. The honeycomb structure according to claim 1, wherein an average thickness T_{1A} of the partition walls in the range of coordinate values of 0 to 0.50 R and an average thickness T_{2A} of the partition walls in the range of coordinate values of 0.50 R to 1.00 R satisfy a relationship of 0.9≤T_{2A}/T_{1A}≤1.1.

3. The honeycomb structure according to claim 1, wherein a cell density D_{1A} in the range of coordinate values of 0 to 0.50 R and a cell density D_{2A} in the range of coordinate values of 0.50 R to 1.00 R satisfy a relationship of 0.9≤D_{2A}/D_{1A}≤1.1.

4. The honeycomb structure according to claim 1, wherein the average value P_{1A} of the porosity (%) of the partition walls in the range of coordinate values of 0 to 0.50 R is 30 to 60%.

5. The honeycomb structure according to claim 1, wherein a relationship of 1.08≤P_{2A}/P_{1A≤}2.5 is satisfied.

6. The honeycomb structure according to claim 1, wherein regarding the porosity of the partition walls, a ratio of the porosity at a coordinate value of 0.35 R to the porosity at a coordinate value of 0 is 0.9 to 1.5; a ratio of the porosity at a coordinate value of 0.75 R to the porosity at the coordinate value of 0.35 R is 1.1 to 2.5; and a ratio of the porosity at a coordinate value 1.00 R to the porosity at the coordinate value of 0.75R is 0.9 to 1.5.

7. The honeycomb structure according to claim 1, wherein an average value P_{1B} of a porosity (%) of the partition walls in a range of coordinate values of 0 to 0.35 R and an average value P_{3B} of the porosity (%) of the partition walls in a range of coordinate values of 0.75 R to 1.00 R satisfy a relationship of P_{1B}<P_{3B}.

8. The honeycomb structure according to claim 7, wherein the average value P_{1B} of the porosity (%) of the partition walls in the range of coordinate values of 0 to 0.35 R, an average value P_{2B} of a porosity (%) of the partition walls in a range of coordinate values of 0.35 R to 0.75 R, and the average value P_{3B} of the porosity (%) of partition walls in the range of coordinate values of 0.75 R to 1.00 R satisfy relationships of 1.1≤P_{2B}/P_{1B}<2.5, 1.1≤P_{3B}/P_{2B}<2.5, and 1.21≤P_{3B}/P_{1B≤}2.5.

9. The honeycomb structure according to claim 7, wherein an average thickness T_{1B} of the partition walls in the range of coordinate values of 0 to 0.35 R, an average thickness T_{2B} in the range of coordinate values of 0.35 R to 0.75 R, and an average thickness T_{3B} in the range of coordinate values of 0.75 R to 1.00 R satisfy relationships of 0.9≤T_{2B}/T_{1B}≤1.1, 0.9≤T_{3B}/T_{2B}≤1.1, and 0.9≤T_{3B}/T_{1B}≤1.1.

10. The honeycomb structure according to claim 7, wherein a cell density D_{1B} in the range of coordinate values of 0 to 0.35 R, a cell density D_{2B} in the range of coordinate values of 0.35 R to 0.75 R, and a cell density D_{3B} in the range of coordinate values of 0.75 R to 1.00 R satisfy relationships of 0.9≤D_{2B}/D_{1B}≤1.1, 0.9≤D_{3B}/D_{2B}≤1.1, and 0.9≤D_{3B}/D_{1B}≤1.1.

11. The honeycomb structure according to claim 1, wherein an average value P_{1C} of a porosity (%) of the partition walls in a range of coordinate values of 0 to 0.20 R and an average value P_{5C} of a porosity (%) of the partition walls in a range of coordinate values of 0.80 R to 1.00 R satisfy a relationship of P_{1C}<P_{5C}.

12. The honeycomb structure according to claim 11, wherein the average value P_{1C} of the porosity (%) of the partition walls in the range of coordinate values of 0 to 0.20 R, an average value P_{2C} of a porosity (%) of the partition walls in a range of coordinate values of 0.20 R to 0.40 R, an average value P_{3C} of a porosity (%) of the partition walls in a range of coordinate values of 0.40 R to 0.60 R, an average value P_{4C} of a porosity (%) of the partition walls in a range of coordinate values of 0.60 R to 0.80 R, and the average value P_{5C} of the porosity (%) of the partition walls in the range of coordinate values of 0.80 R to 1.00 R satisfy relationships of 1.1≤P_{2C}/P_{1C≤}<2.5, 1.1≤P_{3C}/P_{2C}<2.5, 1.1≤P_{4C}/P_{3C}<2.5, 1.1≤P_{5C}/P_{4C}<2.5, and 1.46≤P_{5C}/P_{1C}≤2.5.

13. The honeycomb structure according to claim 11, wherein an average thickness T_{1C} of the partition walls in the range of coordinate values of 0 to 0.20 R, an average thickness T_{2C} of the partition walls in the range of coordinate values of 0.20 R to 0.40 R, an average thickness T_{3C} of the partition walls in a range of coordinate values of 0.40 R to 0.60 R, an average thickness T_{4C} of the partition walls in a range of coordinate values of 0.60 R to 0.80 R, and an average thickness T_{5C} of the partition walls in the range of coordinate values of 0.80 R to 1.00 R satisfy 0.9≤T_{2C}/T_{1C}≤1.1, 0.9≤T_{3C}/T_{2C}≤1.1, 0.9≤T_{4C}/T_{3C}≤1.1, 0.9<T_{5C}/T_{4C}≤1.1, and 0.9<T_{5C}/T_{1C}≤1.1.

14. The honeycomb structure according to claim 11, wherein a cell density D_{1C} in the range of coordinate values of 0 to 0.20 R, a cell density D₃₂ in a range of coordinate values of 0.20 R to 0.40 R, a cell density D_{3C} in a range of coordinate values of 0.40 R to 0.60 R, a cell density D_{4C} in a range of coordinate values of 0.60 R to 0.80 R, and a cell density D_{5C} in the range of coordinate values of 0.80 R to 1.00 R satisfy 0.9≤D_{2C}/P_{1C}≤1.1, 0.9≤D_{3C}/D_{2C}≤1.1, 0.9≤D_{4C}/D_{3C}≤1.1, 0.9≤D_{5C}/D_{4C}≤1.1, and 0.9≤D_{5C}/P_{1C≤}1.1.

15. The honeycomb structure according to claim 1, wherein the porosity of the partition walls gradually increases from the center of gravity O toward the inner peripheral surface of the outer peripheral wall.

16. An electrically heated carrier, comprising:
the honeycomb structure according to claim 1; and
a metal terminal joined to an outer surface of each of the pair of electrode layers.

17. An exhaust gas purification device, comprising:
the electrically heated carrier according to claim 16; and
a tubular metal pipe accommodating the electrically heated carrier.
